(19) United States
(12) Patent Application Publication
(10) Pub. No.: US 2005/0023024 A1
(43) Pub. Date: Feb. 3, 2005

(54) Radiation resistant cross linked polymer compositions and radiation resistant polymer products

(75) Inventors: Sadayoshi Nakatsukasa, Asakuti-gun (JP); Takesi Tabasaki, Fukuyama-shi (JP); Joichi Kusano, Naka-gun (JP); Fumihiro Masukawa, Naka-gun (JP)

Correspondence Address: OLIFF & BERRIDGE, PLC, P.O. BOX 19928, ALEXANDRIA, VA, 22320, US

(73) Assignee: HAYAKAWA RUBBER CO., LTD., Fukuyama-shi (JP)

(21) Appl. No.: 10/893,497

(22) Filed: Jul. 19, 2004

(30) Foreign Application Priority Data
Jul. 31, 2003 (JP) 2003-283989

(51) Int. Cl. H01B 9/00; H01B 11/00; C08L 11/00; C08L 15/00; C08L 19/00

(52) U.S. Cl. 174/68.1; 385/102; 525/55

(57) ABSTRACT

An object of the present invention is to provide a radiation resistant polymer composition for maintaining appropriate physical properties after it is exposed to radiation. The invention provides a radiation resistant cross linked polymer composition comprising polymer components and a softening agent in an amount of 3 weight parts or more with respect to 100 weight parts of the polymer components. The polymer components comprise a first polymer component of one or more polymer selected from the group consisting of butyl rubber, polyisobutylene rubber, epichlorohydrin rubber and polypropylene in a content of 3 to 70 weight parts and a second polymer component of one or more polymer selected from the group consisting of chloroprene rubber and a polymer containing an ethylene unit as a main component in a content of 97 to 30 weight parts.

This application claims the benefit of Japanese Patent Application P2003-283989, filed on Jul. 31, 2003, the entirety of which is incorporated by reference.

### BACKGROUND OF THE INVENTION

1. Field of the Invention

The present invention relates to a radiation resistant cross linked polymer composition suitable for polymer products used as various kinds of cables, packings, water cut-off materials etc. in nuclear related facilities such as nuclear power plants, facilities for reprocessing of used nuclear fuel and proton accelerators.

2. Related Art Statement

It has been proposed various kinds of compositions as a polymer used for facilities relating to nuclear power. Such known polymer compositions are described in, for example, Japanese patent No. 2 8 9 3 3 6 0 B, Japanese Patent examined publication No. 8 -8 6 9, Japanese patent publication 8-1 5 1 4 9 0 A and an article of “Hitachi Cable”, No. 9 (1990-1), pages 77 to 82 “Development of an ultra radiation resistant cable”.

### SUMMARY OF THE INVENTION

It has been demanded still further improved radiation resistance in recent years. As a specific radiation dope, it is required that a polymer maintain an appropriate hardness and bending properties after the polymer is exposed to radiation of, for example, about 5 MGy to 10 MGy. When a polymer composition is subjected to radiation of such high dose level, the polymer composition is deteriorated due to hardening or softening. It has been thus almost impossible to obtain general properties exposed as a polymer composition.

An object of the present invention is to provide a radiation resistant polymer composition for maintaining appropriate hardness and bending properties after it is exposed to radiation.

The present invention provides a radiation resistant cross linked polymer composition comprising polymer components and a softening agent in an amount of 3 weight parts or more with respect to 100 weight parts of the polymer components. The polymer components comprise a first polymer component of one or more polymer selected from the group consisting of butyl rubber, polyisobutylene rubber, epichlorohydrin rubber and polypropylene in a content of 3 to 70 weight parts and a second polymer component of one or more polymer selected from the group consisting of chloroprene rubber and a polymer containing an ethylene unit as a main component in a content of 97 to 30 weight parts.

According to the radiation resistant cross linked polymer composition of the present invention, it is possible to maintain appropriate hardness and physical properties after the exposure to radiation. The radiation resistant cross-linked polymer composition may be applied to polymer products requiring radiation resistance such as those for nuclear related facilities. It is thereby possible to considerably improve the hardness and bending properties after the exposure to radiation compared with those made of compositions previously reported. The present invention is thus very useful in a field of engineering.

The radiation resistant cross-linked polymer composition of the present invention will be described further in detail below.

When a polymer composition is used under circumstances with radiation exposure, the polymer composition is normally exposed to a low dose of radiation over a long time period. Various polymers are thereby deteriorated in the performances and properties due to the exposure to radiation. As a polymer is exposed to radiation, the cross linkage and fragmentation of polymer chains occur at the same time. A polymer may be divided into two categories; cross linking and decomposition types, as which of the cross linking and fragmentation is dominant during the exposure. The cross linking type polymer includes natural rubber, chloroprene rubber, ethylene-propylene rubber, isoprene rubber, styrene-butadiene rubber, butadiene rubber, acrylonitrile-butadiene rubber, polyethylene or the like. The decomposition type polymer includes polyisobutylene rubber, butyl rubber, epichlorohydrin rubber and polypropylene. The cross linking type polymer becomes hard and brittle due to a reduction of elongation and an increase of modulus. The decomposition type polymer becomes brittle due to reduction of tensile strength, elongation and hardness.

The solution for preventing deterioration due to exposure to radiation provided by the present invention is based on a novel concept substantially different from known solutions in the art. It has been added protectants into a radiation resistant polymer so that the species, combination and amounts of the protectants are adjusted. This method is expected to be useful to some degree against a low dose of radiation. This method is, however, proved to be ineffective against a high dose of radiation. Specifically, it has been recently reported that some polymers with specific properties are superior to prior compositions in the art. For example, when such recently reported polymer composition applying the above method may have a breaking elongation at blank of 400 percent or higher, the breaking elongation is reduced to about 20 percent after it is exposed to radiation of 10 MGy. When the breaking elongation is considerably reduced as such, however, it is not appropriate on the viewpoint of bending properties or the like.

The inventors have tried to present a novel concept and perform radiation exposure tests seeking for a substantial breakthrough, and have reached the following novel composition. That is, known radiation resistant polymers previously reported include ethylene-propylene polymer and chloroprene rubber. Such radiation resistant polymer is deteriorated in the hardness after it is exposed to a high dose of radiation, so that its bending properties are lost. An appropriate amount of softening deterioration type polymer such as isobutylene polymer, epichlorhydrin polymer or polypropylene polymer is mixed to the above described hardening deterioration type polymer. It is proved that the deterioration processes due to cross linking and decomposition of the polymer composition may proceed at the same time, so that apparent changes of properties such as surface hardness can be successfully minimized.

These and other objects, features and advantages of the invention will be appreciated upon reading the following description of the invention when taken in conjunction with the attached drawings, with the understanding that some modifications, variations and changes of the same could be made by the skilled person in the art.

### PREFERRED EMBODIMENTS OF THE INVENTION

According to the present invention, in 100 weight parts of polymer components, 3 to 70 weight parts of a first polymer component of at least one polymer selected from the group consisting of butyl rubber, polyisobutylene rubber, epichlorohydrin rubber and polypropylene and 97 to 30 weight parts of a second polymer component of one or more polymer selected from the group consisting of chloroprene rubber and a polymer containing an ethylene unit as a main component are blended.

The polymer composition can be properly and controllably degraded with decomposition by adjusting the total content of the first polymer component to 3 weight parts or more. It is thus possible to prevent increases of surface hardness and modulus and a reduction of elongation due to cross linkage degradation of the second polymer component,. On the viewpoint, the total content of the first polymer component may preferably be 3 weight parts or higher and more preferably be 5 weight parts or higher.

The reduction of surface hardness, modulus and breaking properties of the polymer composition can be prevented by adjusting the total content of the first polymer component to 70 weight parts or lower. On the viewpoint, the total content of the first polymer component may preferably be 70 weight parts or lower, and more preferably 40 weight parts or lower.

Many cross linking type polymer are known other than the above listed chloroprene and a polymer containing ethylene units as the main component applied as the second polymer component according to the present invention. When some cross linking type polymers not listed are used, it is proved that the properties such as breaking strength of the polymer composition is considerable. The characteristic performances of the composition of the present invention cannot be obtained.

The first polymer component is of a polymer selected from the group consisting of butyl rubber, polyisobutylene rubber, epichlorohydrin rubber and polypropylene, or the mixtures thereof.

Butyl rubber means a copolymer of isoprene and isobutylene. Although various grades of butyl rubbers are produced and commercialized depending on the polymer composition, molecular weight or the like, the polymer composition and molecular weight are not particularly limited.

Polyisobutylene rubber is a polymer substantially composed of isobutylene, and the molecular weight is not particularly limited.

Epichlorhydrin rubber is a product of ring-opening polymerization containing epichlorhydrin, ethylene oxide, allyl glycidyl ether as the main components.

Polypropylene is a polymer of propylene, and the molecular weight is not particularly limited. Further, a small amount of the other monomer, such as ethylene monomer, may be added in the polymerization process.

The second polymer component is composed of a polymer selected from the group consisting of chloroprene rubber and a polymer containing an ethylene unit as a main component, and the mixtures thereof.

In the polymer containing ethylene unit as the main component, preferably 30 mole percent or higher, more preferably 40 mole percent or higher, of the monomer units are occupied by ethylene units. The polymer includes polyethylene (PE), and denatured polyethylenes such as chlorosulfonated polyethylene rubber (CSM) and chlorinated polyethylene rubber (CM). The polymer may be a two-component copolymer of ethylene and propylene, or a multi-component polymer (such as terpolymer and tetramer) of ethylene, propylene and the other monomer(s). In the case of ethylene-propylene series polymer, it is preferred that propylene units occupy 20 mole percent or more of the whole monomer units. The other monomer includes ethylidene norbornene, dicyclopentadiene, 1,4-hexadiene and vinylidene norbornene.

Chlorosulfonated polyethylene may be produced by subjecting polyethylene to chlorosulfonation reaction. Chlorinated polyethylene may be produced by subjecting polyethylene to a chlorination reaction.

According to the present invention, 3 weight parts or more of a softening agent is added to 100 weight parts of polymer components. It is thereby possible to prevent the deterioration due to hardening of the polymer composition. On the viewpoint, the total content of the softening agent may preferably be 3 weight parts or more, and more preferably be 10 weight parts or more. Although the upper limit of amount of the softening agent is not particularly defined, it may be 100 weight parts or lower, for example.

The “softening agent” is a general terminology of additives added to the composition for reducing the hardness of a polymer. The “softening agent” includes a so-called plasticizer. The softening agent has high compatibility with a polymer and may penetrate into the molecular chains to function as a kind of a lubricator between the molecular chains.

The softening agent includes a mineral oil softening agent, a vegetable oil softening agent, and a synthetic softening agent (synthetic plasticizer).

The mineral oil softening agent may be categorized into aromatic, naphthene and paraffin systems. Mineral oil softening agents available are normally composed of a mixture of these three systems.

According to a preferred embodiment, the softening agent is a mineral oil softening agent having an aniline point of 60° C. or lower. An aniline point is used as a scale for indicating the content of aromatic structure such as benzene ring in the softening agent. According to the present invention, it is possible to effectively prevent the deterioration due to hardening of a polymer composition, by applying a softening agent having an aniline point of 60° C. or lower (more preferably 45° C. or lower). Such softening agent includes the followings.

For example, “AC” and “AH” series supplied by Idemitsu Kosan Co.,Ltd., “HA” series supplied by KOBE OIL CHEMICAL INDUSTRIAL Co., Ltd., and products supplied by COSMO OIL CO., LTD., JAPAN ENERGY CORPORATION, Japan Sun Oil Company Ltd., FUJI KOSAN CO., LTD or the like.

A plasticizer is a general terminology of synthesized agents among the softening agents. The kind of the plasticizer is not limited, and may preferably be a polyvalent carboxylic ester plasticizer. Particularly preferably, an aromatic polyvalent carboxylic ester plasticizer is used. Such polyvalent carboxylic acid may preferably have a benzene ring therein such as terephthalic acid, isophthalic acid or trimellitic acid. An alcohol to be reacted with the polyvalent carboxylic acid may be methanol, ethanol, butanol, pentanol, hexanol, octanol, ethyl hexanol, octanol, caprylic alcohol, nonanol, isononyl alcohol, decanol, isodecyl alcohol, undecyl alcohol, lauryl alcohol, tridecyl alcohol, benzyl alcohol, or cyclohexanol. More preferably, the plasticizer may be a phthalic acid series plasticizer such as DOP (di-2-ethyl hexyl phthalate), DBP (dibutyl phthalate), BBP (butyl benzyl phthalate) or the like; or trimellitic ester series plasticizer such as TBTM (tributyl.trimilitate), TOTM (tri.2-ethyl hexyl.trimellitate) or the like.

According to the polymer composition of the present invention, protectants known in radiation resistant polymer specifications may be used. Such protectants includes electron•ion capturing agents, energy transfer agents, antioxidants, radical capturing agents and radical inactivating agents.

The electron•ion capturing agents include pyrene, quinone, diphenylenediamine, tetramethyl phenylenediamine or the like. The energy transferring agents include acenaphthene, acenaphthylene etc. The radical capturing agents include mercaptan, phenyl ether, and hydrophenanthrene. The antioxidants include various kinds of phenols and an organic thioate.

Various kinds of compounding agents and additives may be added to the polymer composition of the present invention. Specifically are listed various kinds of cross linking agents required for cross linkage, a cross linkage accelerator, stearic acid, a cross linkage aid such as zinc oxide, an age resistor of phenolic series, amine series and quinone series, an ultraviolet absorbent such as benzophenone, hindered amine benzotriazole, and salicylic acid derivative, a filler such as calcium carbonate, clay, magnesium carbonate or the like, a reinforcing agent such as carbon black, silica and surface treated calcium carbonate, the other processing aids, a foaming agent, a flame retarder, a colorant, a tackifier and so on. Although sulfur is used as a cross linking agent in many rubber compositions, the other metal oxides and organic peroxides may be used in the composition of the present invention.

### EXAMPLES

The present invention will be described further in detail referring to the following inventive and comparative examples.

Each of blending compositions shown in table 1 was kneaded with a pressure kneader having a volume of 1 liter at 100° C. for 20 minutes to obtain kneaded blend, which was then rolled by a 6-inch open roll to obtain a sheet shaped sample having a length of 2 mm. The sample was then vulcanized and shaped by a press at 170° C. for 20 minutes. The samples 1 to 4 shown in table 1 were within the present invention and the samples 5 to 7 were not within the present invention. Further, each blend shown in table 1 was shown as a reference numeral in a parenthesis. The reference numeral in each parenthesis corresponds to each reference numeral shown in table 2.

TABLE 1

| Composition | 1 | 2 | 3 | 4 | 5 | 6 | 7 |
|---|---|---|---|---|---|---|---|
| EPDM (1) | 80 | 10 | 60 | 93 | 98 | 0 | 25 |
| CSM (2) | 5 | 0 | 0 | 0 | 0 | 65 | 0 |
| B-10 (3) | 0 | 50 | 0 | 0 | 0 | 0 | 0 |
| Second polymer | 85 | 60 | 60 | 93 | 98 | 65 | 25 |
| Component | | | | | | | |
| IIR (4) | 15 | 40 | 40 | 7 | 2 | 35 | 75 |
| IBR (5) | 0 | 5 | 0 | 0 | 0 | 0 | 0 |
| First polymer | 15 | 45 | 40 | 7 | 2 | 35 | 75 |
| Component | | | | | | | |
| Softening | 15 | 30 | 0 | 28 | 20 | 1 | 10 |
| Agent (6) | | | | | | | |
| Plasticizer (7) | 0 | 10 | 30 | 0 | 20 | 0 | 40 |
| Total content | 15 | 40 | 30 | 28 | 40 | 1 | 50 |
| Of (6) and (7) | | | | | | | |
| Carbon (8) | 35 | 50 | 0 | 55 | 50 | 45 | 0 |
| Silica (9) | 5 | 0 | 50 | 20 | 0 | 10 | 30 |
| Clay (10) | 0 | 20 | 50 | 0 | 0 | 10 | 50 |
| Additives | 9 | 9 | 8 | 15 | 8 | 7 | 6.5 |
| (11)˜(14) | | | | | | | |
| Stearic acid (15) | 1 | 1 | 1 | 1 | 1 | 1 | 1 |
| Zinc white (16) | 5 | 5 | 5 | 5 | 5 | 5 | 5 |
| MgO (17) | 0.5 | 3 | 1.5 | 0 | 0 | 3.5 | 0 |
| Sulfur (18) | 1.5 | 0.5 | 1 | 2 | 1.5 | 0.6 | 1.5 |
| Accelerator | 4.3 | 2 | 4.8 | 4.6 | 3.7 | 3.2 | 4.5 |
| (19)˜(22) | | | | | | | |

TABLE 2
<materials for use>

| | | |
|---|---|---|
| *(1) | EPDM #4045 | Mitsui Chemicals, Inc. |
| *(2) | Hypalon #40 | SHOWA DENKO K.K. |
| *(3) | B-10 | TOSOH CORPORATION |
| *(4) | IIR #268 | JSR |
| *(5) | Vistanex L-140 | Exxon |
| *(6) | AH-16 | Idemitsu sekiyu |
| *(7) | DOP | Daihachi Chemical Industry Co., Ltd. |
| *(8) | Asahi #60 | Asahi Carbon |
| *(9) | Nipp Seal AQ | Japan silica industry |
| *(10) | Dixie Clay | Vander Bilt |
| *(11) | Bio Soap 100 | KYODO CHEMICAL CO., LTD. |
| *(12) | Adecus tab LA-32 | Asahi Denka Co., Ltd. |
| *(13) | Noklak CD | OUCHISHINKO CHEMICAL |
| | | INDUSTRIAL CO., LTD. |
| *(14) | Noklak 8C | OUCHISHINKO CHEMICAL |
| | | INDUSTRIAL CO., LTD. |
| *(15) | Lunak S-20 | Kao corporation |
| *(16) | zinc white 3 [symbol] | Shodo chemical |
| *(17) | Magnesium oxide #150 | Kyowa Chemical |
| *(18) | Sulfax PS | Tsurumi Chemical Industry |
| *(19) | Noksellar M | OUCHISHINKO CHEMICAL |
| | | INDUSTRIAL CO., LTD. |
| *(20) | Noksellar TT | OUCHISHINKO CHEMICAL |
| | | INDUSTRIAL CO., LTD. |
| *(21) | Noksellar BZ | OUCHISHINKO CHEMICAL |
| | | INDUSTRIAL CO., LTD. |
| *(22) | Accel 22-S | Kawaguchi Chemical |

As shown in table 1, “EPDM” represents a terpolymer of ethylene, propylene and diene, “CSM represents chlorosulfonated polyethylene, and “B-10” represents chloroprene rubber. These three components belong to the second polymer component. “IIR” represents butyl rubber, and “IBR” represents polyisobutylene rubber. The aniline point of the softening agent (6) is 20.5° C. and the plasticizer is DOP. Each dose of 3 MGy, 7MGy and 10 MGy was radiated to each sample of the blending examples. Hs (surface hardness) was measured according to JIS K 6263 and TSB (breaking strength) and ELB (breaking elongation) were measured according to JIS 6251, before and after the irradiation. The results were shown in table 3.

TABLE 3

| Bending | | | | | | | | |
|---|---|---|---|---|---|---|---|---|
| examples | | 1 | 2 | 3 | 4 | 5 | 6 | 7 |
| Blank | Hs | 51 | 50 | 55 | 63 | 46 | 69 | 49 |
| | TS | 13 | 17.9 | 14.8 | 17.4 | 14.7 | 18.8 | 16.2 |
| | EL | 700 | 610 | 720 | 690 | 820 | 640 | 760 |
| 3 | Hs | 56 | 55 | 57 | 71 | 70 | 79 | 50 |
| MGy | TS | 9.7 | 12.5 | 11.9 | 15.9 | 7.7 | 7.1 | 6.5 |
| | EL | 510 | 570 | 600 | 450 | 130 | 190 | 500 |
| 7 | Hs | 68 | 51 | 53 | 77 | 85 | 88 | 44 |
| MGy | TS | 7.2 | 8.4 | 9.1 | 20.2 | 6.2 | 6.6 | 6.2 |
| | EL | 220 | 260 | 270 | 170 | 70 | 80 | 810 |
| 10 | Hs | 73 | 44 | 49 | 81 | 88 | 91 | 32 |
| MGy | TS | 6.8 | 7.3 | 8.3 | 25.8 | 5.5 | 5.9 | 4.7 |
| | EL | 120 | 200 | 190 | 140 | 50 | 40 | 990 |

| | | | | | | | |
|---|---|---|---|---|---|---|---|
| Judgement | Good | Good | Good | Good | Deterio- | Deterio- | Deterio- |
| of Results | | | | | ratio | Ration | Ration |
| about Ra- | | | | | Due to | Due to | Due to |
| diation | | | | | Hardening | Harden- | Soften- |
| Resistance | | | | | | ing | ing |

According to the blending example 1, 85 weight parts of the second polymer component and 15 weight parts of the first polymer component were mixed to obtain mixture, to which 15 weight parts of the softening agent (6) was added. As a result, even after the sample is exposed to radiation of a dose of 10 MGy, the rise of the surface hardness and the reduction of the breaking strength and elongation were proved to be small.

According to the blending example 2, 60 weight parts of the second polymer component and 45 weight parts of the first polymer component were mixed to obtain mixture, to which 40 weight parts of the softening agent (6) and plasticizer (7) were added. As a result, even after the sample is exposed to radiation of a dose of 10 MGy, the rise of the surface hardness and the reduction of the breaking strength and elongation were proved to be small.

According to the blending example 3, 60 weight parts of the second polymer component and 40 weight parts of the first polymer component were mixed to obtain mixture, to which 30 weight parts of the softening agent (6) and plasticizer (7) were added. As a result, even after the sample is exposed to radiation of a dose of 10 MGy, the rise of the surface hardness and the reduction of the breaking strength and elongation were proved to be small.

According to the blending example 4, 93 weight parts of the second polymer component and 7 weight parts of the first polymer component were mixed to obtain mixture, to which 28 weight parts of the softening agent (6) and plasticizer (7) were added. As a result, even after the sample is exposed to radiation of a dose of 10 MGy, the rise of the surface hardness and the reduction of the breaking strength and elongation were proved to be small.

According to the blending example 5, 98 weight parts of the second polymer component and 2 weight parts of the first polymer component were mixed to obtain mixture, to which 40 weight parts of the softening agent and plasticizer were added. As a result, after the sample is exposed to radiation of a dose of 10 MGy, the rise of the surface hardness and the reduction of the breaking elongation were proved to be considerable.

According to the blending example 6, 65 weight parts of the second polymer component and 35 weight parts of the first polymer component were mixed to obtain mixture, to which 1 weight parts of the softening agent and plasticizer were added. As a result, after the sample is exposed to radiation of a dose of 10 MGy, the rise of the surface hardness and the reduction of the breaking strength and elongation were proved to be considerable.

According to the blending example 7, 25 weight parts of the second polymer component and 75 weight parts of the first polymer component were mixed to obtain mixture, to which 50 weight parts of the softening agent and plasticizer were added. As a result, after the sample is exposed to radiation of a dose of 10 MGy, the surface hardness was lowered, and the reduction of the breaking strength was considerable and the breaking elongation was slightly elevated.

As described above, it is proved that the deterioration of the surface hardness, breaking strength and breaking elongation can be prevented, even after the composition is exposed to a high level dose of radiation within a composition range according to the present invention.

The present invention provides a composition exhibiting high level of physical properties as shown in the above examples even after the composition is exposed to a high level dose of radiation, which is the first case in the world.

The present invention has been explained referring to the preferred embodiments , however , the present invention is not limited to the illustrated embodiments which are given by way of examples only, and may be carried out in various modes without departing from the scope of the invention.

1. A radiation resistant cross linked polymer composition comprising polymer components and a softening agent in an amount of 3 weight parts or more with respect to 100 weight parts of said polymer components, said polymer components comprising a first polymer component of one or more polymer selected from the group consisting of butyl rubber, polyisobutylene rubber, epichlorohydrin rubber and polypropylene in a content of 3 to 70 weight parts and a second polymer component of one or more polymer selected from the group consisting of chloroprene rubber and a polymer containing an ethylene unit as a main component in a content of 97 to 30 weight parts.

2. The composition of claim 1, wherein said polymer containing an ethylene unit comprises one or more component selected from the group consisting of ethylene-propylene rubber, chlorosulfonated polyethylene rubber, polyethylene and chlorinated polyethylene rubber.

3. The composition of claim 1, wherein said softening agent has an aniline point of 60° C. or lower.

4. The composition of claim 1, wherein said softening agent comprises a plasticizer of an aromatic carboxylic ester.

5. A radiation resistant polymer product comprising the composition of claim 1.

6. The product of claim 5, comprising a distribution line, a power cable, a communication cable, a sheath, a water cut-off material or a packing.
